(19) United States
(12) Patent Application Publication
(10) Pub. No.: US 2010/0294622 A1
(43) Pub. Date: Nov. 25, 2010

(54) METHOD OF TRANSPORTING CONTAINERS WHILE SUPPORTED BY PARTIAL ENGAGEMENT, AND AN INSTALLATION IMPLEMENTING THE METHOD

(75) Inventor: André GRAFFIN, Winfield (FR)

Correspondence Address: Muncy, Geissler, Olds & Lowe, PLLC, 4000 Legato Road, Suite 310, FAIRFAX, VA, 22033, US

(73) Assignee: SERAC GROUP, La Ferte Bernard (FR)

(21) Appl. No.: 12/784,213

(22) Filed: May 20, 2010

(30) Foreign Application Priority Data
May 20, 2009 (FR) 0902461

(51) Int. Cl. B65G 47/86; B65G 47/84; B65G 29/00

(52) U.S. Cl. 198/470.1; 198/485.1; 198/473.1

(57) ABSTRACT

A method of transporting containers, each comprising a body having a bottom and, at its opposite end, a mouth, the method comprising the steps of:
supporting each container over a portion only of its bottom by means of a support that is movable with the container, and centering the mouth of the container on a container travel path, the centering being provided by clamping a portion of the container in the neighborhood of its mouth; and
moving the containers as supported in this way.

### FIELD OF THE INVENTION

The present invention relates to a method of transporting containers, which method is suitable, for example, for use in moving containers through an installation for processing containers, e.g. comprising a washer, a blower, a filler, a closer, and/or a labeler. The invention also provides such an installation. The invention applies more particularly to moving containers along paths that are circular, at least in part, through installations that include members for grasping the containers traveling along said paths.

### BACKGROUND OF THE INVENTION

Installations are known that comprise a stand having adjacent platforms mounted thereon to define a container travel path that winds around part of each platform. Each platform is provided with a support arranged to support the bottom of each container by engaging it in full. Rotary transfer stars are mounted between the rotary platforms and have cells for receiving half of the outline of the body of a container and for moving containers on a support that extends in stationary manner relative to the stand between the supports of two platforms so that the containers are supported while the transfer star is transferring them from one platform to the other. That requires tooling having a shape that corresponds to the shape of the body of a container.

At present, there exist installations having adjacent rotary platforms in which one has a support arranged to engage the bottoms of containers in full and another has means for gripping the body of each container. The gripper means, e.g. clamps, are arranged to take charge of each container where the path passes from one platform to the other. This requires grasping tooling to be available that is specific for each type of container.

### OBJECT AND SUMMARY OF THE INVENTION

An object of the invention is to transport containers in a container-processing installation while limiting recourse to grasping tooling that is specific to each type of container.

For this purpose, the invention provides a method of transporting containers, each comprising a body having a bottom and, at its opposite end, a mouth, the method comprising the steps of:
supporting each container over a portion only of its bottom by means of a support that is movable with the container, and centering the mouth of the container on a container travel path; and
moving the containers as supported in this way.

Thus, the containers are grasped mainly by a support that engages only a portion of the bottom of each container, which does not put any particular geometrical constraint on the support device. Friction is limited to a portion only of the bottom of each container while the container is being put into place on a support or removed therefrom.

Preferably, the centering of each container is provided by clamping a portion of the container in the neighborhood of its mouth.

This improves the stability of the containers while they are being moved. It is not necessary under such circumstances to clamp the container firmly since the essential part of the grasping function is provided by the support, the clamping serving only to ensure that the mouth is centered. In addition, all containers generally have a bottom and a neck, such that using these two portions of the body of a container for transport purposes makes it possible to use tooling that is common to a wide variety of containers, with a few adaptations or adjustments possibly being needed, e.g. associated with the height of the containers.

Advantageously, each container is supported over about half of its bottom.

This constitutes a good compromise between supporting the containers effectively and reducing friction.

Preferably, the containers are transferred from an upstream platform towards a downstream platform, both platforms being provided with a support for each container, and the containers are separated from the support of the upstream platform during the transfer, and either:
separation is obtained by lowering the support of the upstream platform; or else
separation is obtained by raising the support of the downstream platform.

This serves to facilitate transferring containers from one platform to another.

The invention also provides an installation for processing containers, each container comprising a body having a bottom and, at its opposite end, a mouth, the installation comprising at least one rotary platform provided with at least one support for supporting the bottoms of the containers, the support being constrained to rotate with the platform and being arranged to support a portion only of the bottom of each container. The installation includes devices for centering the mouths of the containers on a predefined travel path.

Thus, any recourse to tooling specific to each shape of container is limited. In addition, friction is limited to the supported portion of the bottom of each container while the container is being put into place on the support or removed therefrom.

Preferably, the support extends no further than said path.

This provides a good compromise between the effectiveness of the support and the overall size thereof.

In a first embodiment, the support comprises at least one ring sector extending around at least part of the platform to support at least one container.

This embodiment is particularly simple.

In a second embodiment, the installation has a plurality of supports each arranged to support one container, and, preferably, each support comprises a seat mounted to pivot about a horizontal axis between a raised position into which it is urged resiliently by a spring, and a lowered position into which it is moved by a stationary cam.

The movement of the seat serves to eliminate friction and to limit any risk of the seat interfering with the bottom of a container while the container is being put into place on a platform.

Advantageously, the installation comprises at least two adjacent platforms, each provided with at least one support, with the container travel path winding around at least part of each of the platforms, the supports being tangential to each other at a point where the path passes from one platform to the other.

Thus, containers are transferred from one platform to another while limiting friction and while also ensuring good stability for the containers.

Other characteristics and advantages of the invention appear on reading the following description of a particular non-limiting embodiment of the invention.

### BRIEF DESCRIPTION OF THE DRAWINGS

Reference is made to the accompanying drawings, in which:

FIG. 1 is a plan view of an installation in accordance with the invention;

FIG. 2 is a fragmentary perspective view of the installation;

FIG. 3 is an enlarged view of zone III of FIG. 2;

FIG. 4 is a perspective view of zone IV of FIG. 1;

FIG. 5 is a perspective view of zone V of FIG. 1;

FIG. 6 is an enlarged perspective view of zone VI of FIG. 1; and

FIG. 7 is a fragmentary plan view of an installation in a variant embodiment.

### MORE DETAILED DESCRIPTION

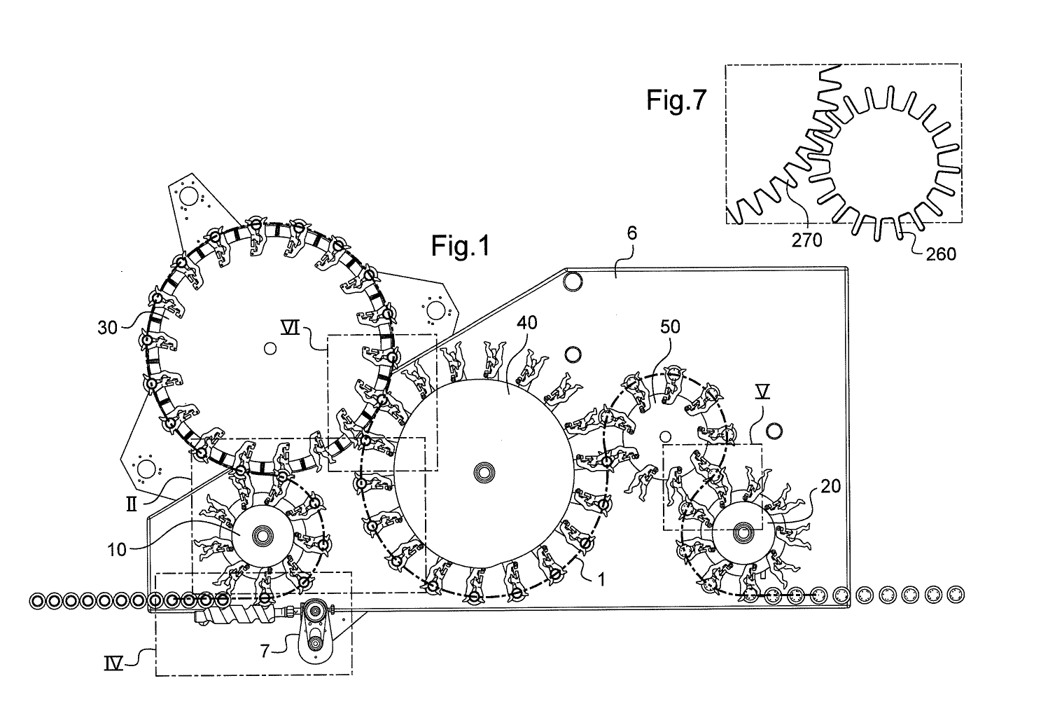

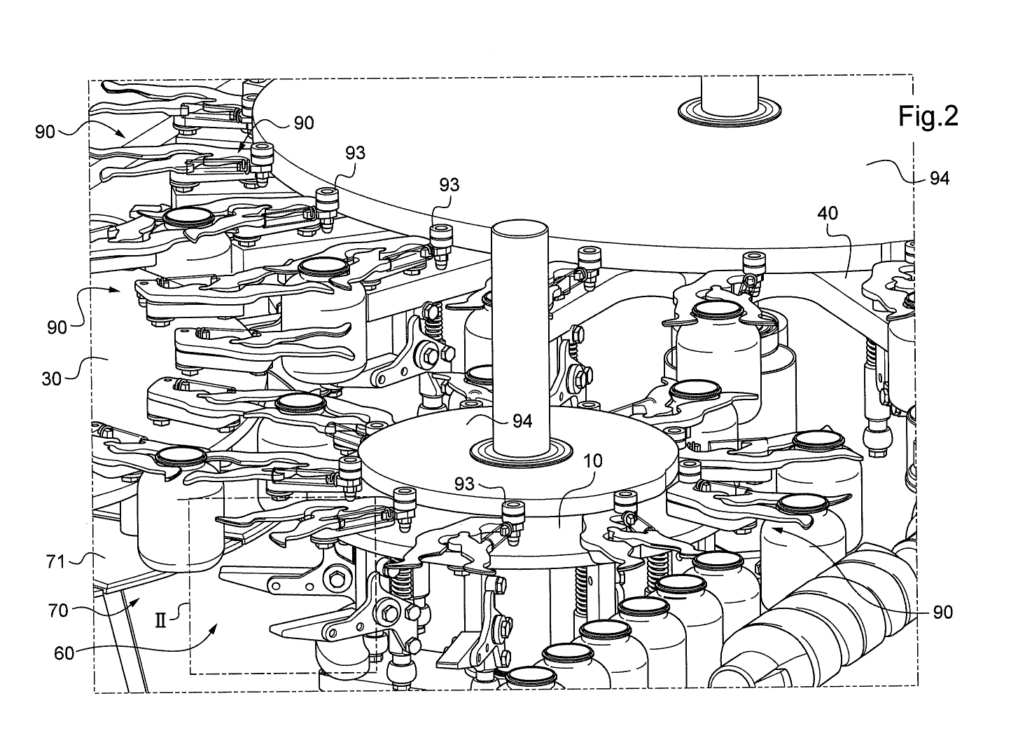

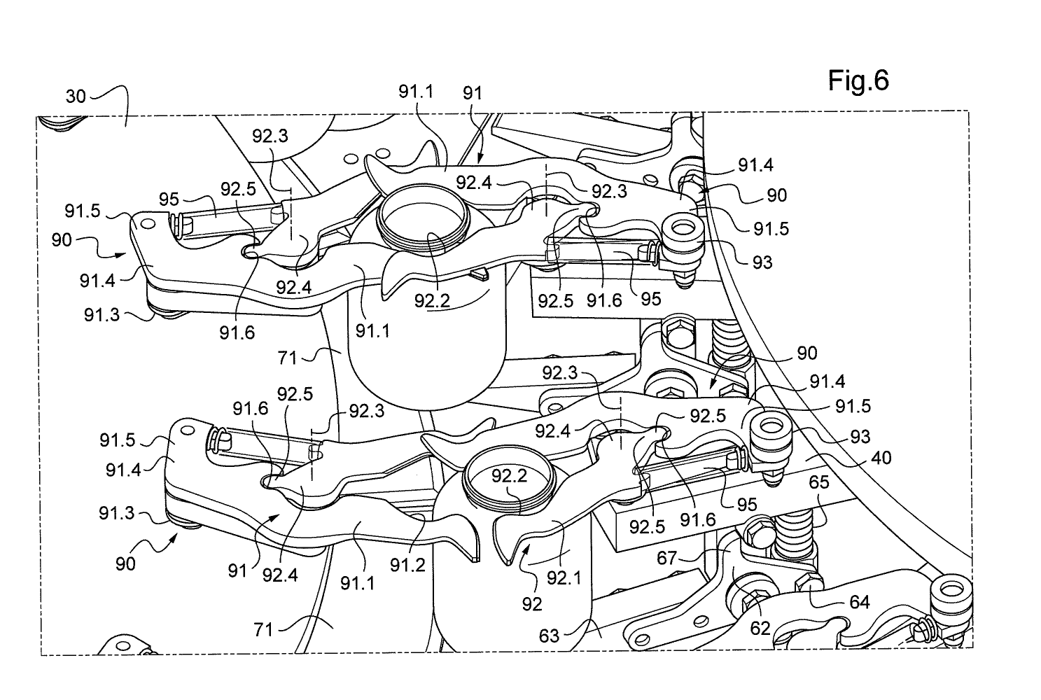

With reference to FIGS. 1 to 6, the installation in accordance with the invention as described herein is for processing containers given overall reference 100, each comprising a body 101 having a bottom 102 and at its opposite end a mouth 103 at the end of a neck 104, which mouth is fitted with a cap 105 at the end of the processing.

The installation comprises a stand 5 having a plurality of adjacent platforms 10, 20, 30, 40, and 50 pivotally mounted thereon, i.e. platforms constituting two transfer stars (inlet platform 10 and outlet platform 20), a carousel for performing blowing or other treatment (platform 30), a filling carousel (platform 40), and a capping carousel (platform 50). The platforms 30, 40, and 50 are surmounted respectively by a blower device, a filler device, and a capping device that are not shown.

The installation defines a path 1 followed by the containers through the installation in such a manner that the centers of the mouths 103 of the containers 100 are centered on said path 1. The path winds around parts of the platforms 10, 20, 30, 40, and 50. The installation includes a feed device for inserting containers 100 into the installation, which device brings the containers 100 up to the platform 10, and it also includes a remover device for taking charge of the containers 100 carried by the platform 20 and for taking them away from the installation. By way of example, these devices are wormscrew devices, such as the device referenced 7, which is used for inserting the containers into the installation.

Each of the platforms 10, 20, 40, and 50 is provided in its bottom portion with a set of supports, each individual support being given an overall reference 60. The platform 30 is provided with a support given overall reference 70. The supports 60 and 70 are constrained to rotate with the corresponding platforms 10, 20, 40, 50, and 30, respectively.

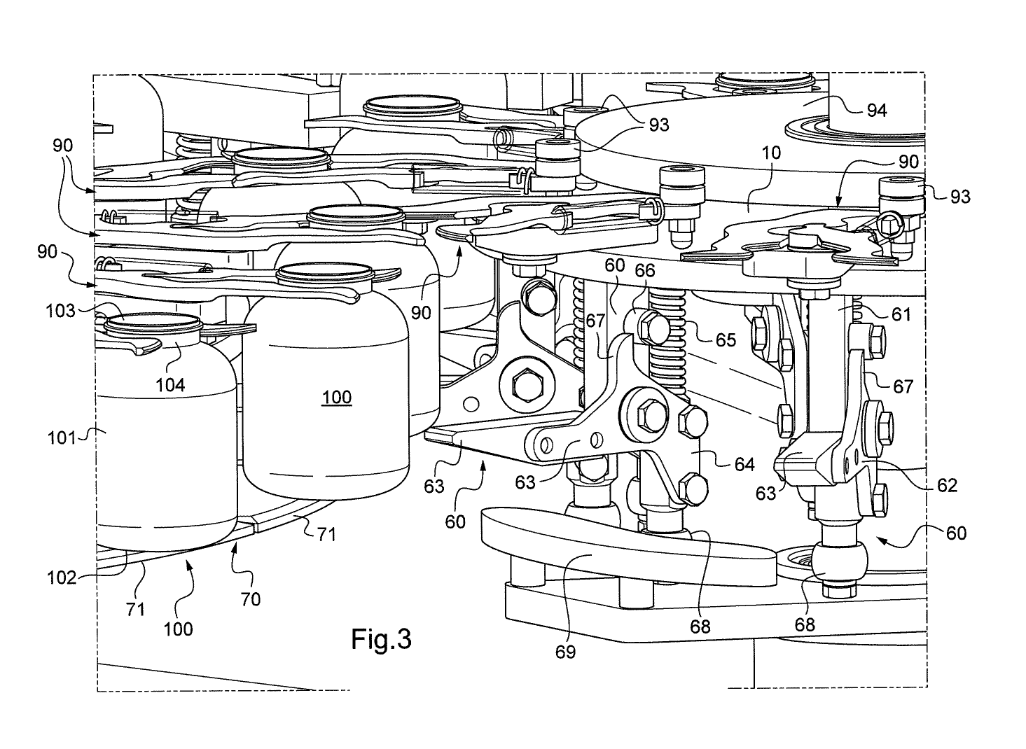

Each support 60 comprises a column 61 extending under the platform 10, 20, 40, or 50 and having a free end with a rocker 62 hinged thereto. The rocker 62 has one end forming a seat 63 and an opposite end 64 that is connected to the corresponding platform 10, 20, 40, or 50 by a spring 65 (see in particular FIG. 3). The rocker 62 is movable between lowered and raised positions of the seat 63, and the spring 65 serves to return the rocker 62 towards the raised position for the seat 63. The raised position is defined by an abutment 66 secured to the column 61 and against which a portion 67 of the rocker 62 comes to bear when the seat 63 is in the raised position. The end 64 is provided with a wheel 68 that is rotatable about an axis perpendicular to the platform 10, 20, 40, or 50 so as to co-operate during rotation of the corresponding platform with a cam 69 that is secured to the stand 5 and that is arranged to bring the rocker 62 into the lowered position of the seat 63.

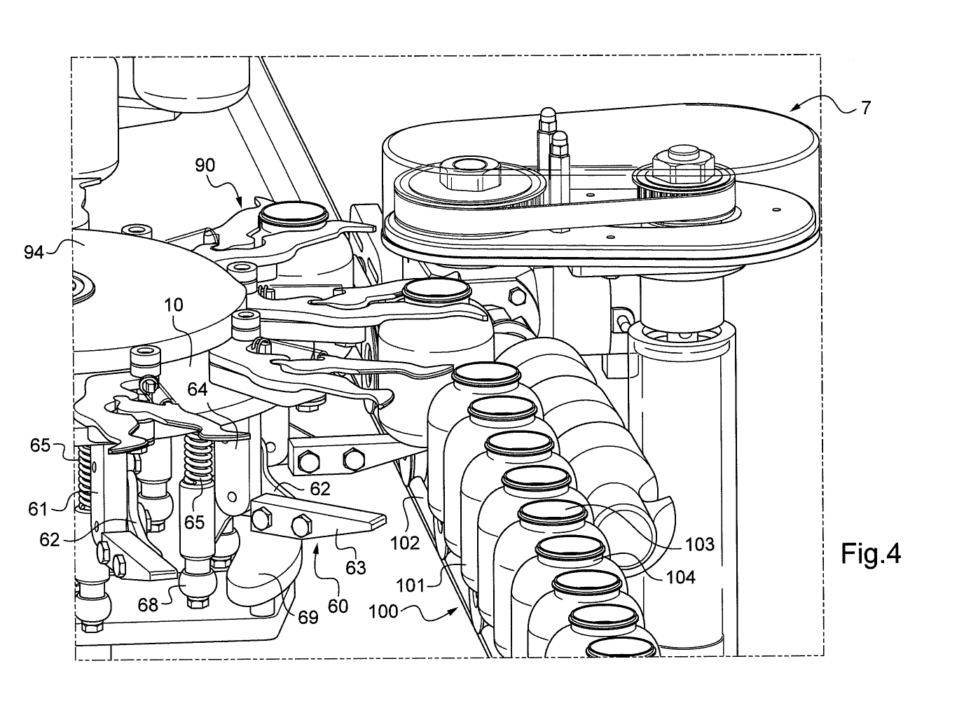

The support 70 comprises ring segments 71 arranged around the axis of the platform 30 (see in particular FIGS. 3 and 4). The ring segments 71 are at a fixed height.

The seat 63 and the ring segments 71 are arranged to support no more than half of a bottom 102 and they extend as far as the path 1. Thus, the containers 100 can be transferred directly from one platform to another in the zone where the path 1 passes from one platform to another and where the supports 60 and 70 are tangential to one another.

Each of the platforms 10, 20, 30, 40, and 50 is provided in its top portion with clamps given overall reference 90 that serve to hold the containers 100 on the supports 60, 70.

Each clamp 90 comprises two arms 91, 92 having portions forming jaws 91.1, 92.1 that are provided with V-shaped cutouts 91.2, 92.2 for clamping onto a body 101 in the neighborhood of its mouth 103, and more particularly its neck 104 (except for the clamps 90 secured to the platform 20, which clamp onto the caps 105 that are engaged on the necks 104). The arm 91 in each clamp 90 is hinged to the corresponding platform 10, 20, 30, 40, or 50 about an axis 91.3, and the arm 92 is hinged both to the corresponding platform 10, 20, 30, 40, or 50 about an axis 92.3 and to the other arm 91 in such a manner that the arms 91 and 92 open symmetrically about a direction that is radial relative to the corresponding platform 10, 20, 30, 40, or 50. The axes 91.3 and 92.3 are vertical and they intersect radial directions of said platform perpendicularly. The axis 91.3 is mounted at an end 91.4 opposite from the portion forming the jaw 91.1 and it is provided with a lever 91.5 carrying a vertical axis wheel 93 for co-operating, during rotation of the corresponding platform, with a cam 94 that is stationary relative to the stand 5 and that is arranged to control the pivoting of the arm 91 to cause it to open (the wheels 93 and the cam 94 are not shown on the platform 30). The axis 92.3 is mounted at an end 92.4 opposite from the portion forming the jaw 92.1 and it is provided with a lever 92.5 having a droplet-shaped free end engaged in a housing 91.6 formed by a rounded cutout that is made in the arm 91 so that the arm 91 moving into its open position causes the arm 92 to move through the same amplitude towards its open position. A compression coil spring 95 extends between the lever 91.5 and the portion forming the jaw 92.1 to return the arms 91 and 92 towards their closed position.

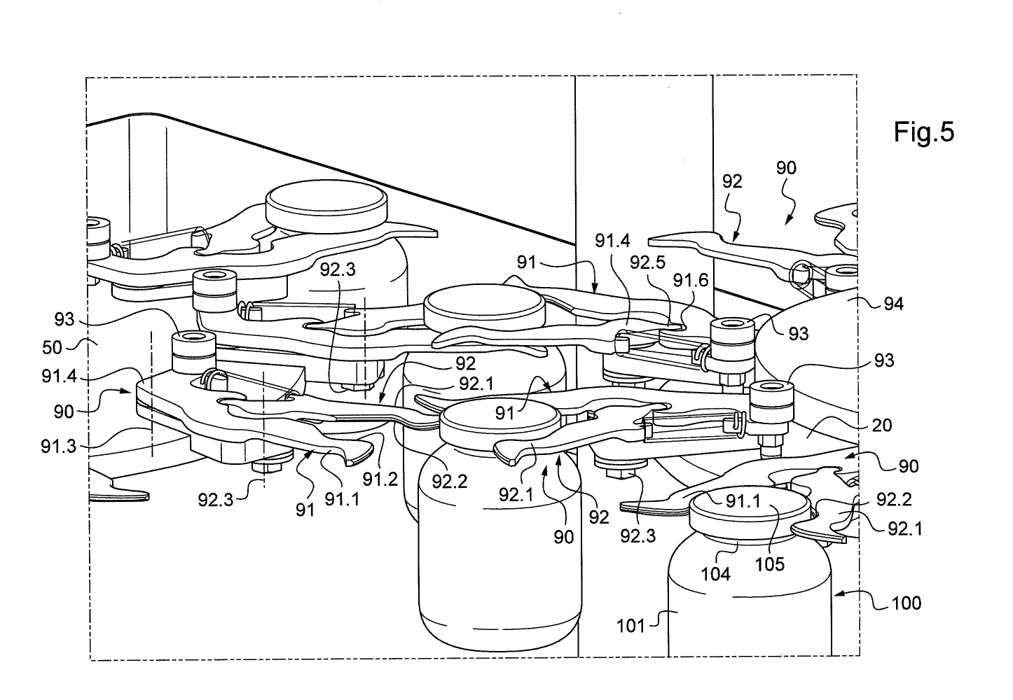

The clamp 90 is thus suitable for holding mouths 103 centered on the path 1 for necks of different diameters. Thus, in FIG. 5 the clamps 90 secured to the platform 50 are holding the containers 100 by the bottom portions of their necks 104, while the clamps 90 of the platform 20 are holding the containers 100 via the caps 105 engaged on the necks 104, which caps are of outside diameter greater than the outside diameter of the necks.

The variant of FIG. 7 shows an installation having two platforms, each fitted with a respective support 260, 270 (which are the only items shown in the figure). Each support comprises a disk or ring having a toothed outer periphery so that the teeth of each support are interleaved at the point of tangency between two adjacent teeth of the other support.

Thus, the containers are supported over the full width of their bottoms as measured in the radial directions of the platforms, but over only a fraction of the dimension of their bottoms as measured transversely to the radial directions.

Two teeth of the supports 260, 270 are therefore capable of supporting the same container simultaneously at the point of tangency between the platforms.

Naturally, the invention is not limited to the embodiment described and covers any variant coming within the field of the invention as defined by the claims.

In particular, an installation may have some other number of supports 60 and/or 70, and for example may have only supports 60 or only supports 70.

Each support 70 may comprise a single one-piece ring.

The supports 60 and 70 may engage more or less than half of the bottom of a container, but they cannot engage the entire bottom of any container.

Nevertheless, the installation may include both supports analogous to the supports 60 and 70 and traditional supports that do engage the bottoms of the containers in full.

The supports 60 and 70 may be at a height that is adjustable by means of a vertical axis screw-and-nut system or by any other means, e.g. including linear electrical actuators or jacks. By connecting the seats 63 of the supports 60 to the columns 61 via a deformable parallelogram device, it is possible to have a support that adapts automatically to the height of a container.

The structure of the clamp is completely independent of the way the containers are supported via their bottoms. Other types of devices for holding containers on the supports may be envisaged, in particular resilient clamps, individually controlled clamps, open cells facing a rail for holding the containers in the cells, . . . .

The clamps may grip the containers on a portion of a container body other than its neck, for example a central portion of the body.

Preferably, in installations in which at least one of the supports is movable vertically:
the vertically-movable support is situated downstream and rises to bear against the bottom of the container and to lift it off the support situated upstream; and/or
the vertically-movable support is situated upstream and lowers to put the container down on the support that is situated downstream. The upward and downward movements of the supports are implemented by means of cams such as the cams 69. This serves to facilitate transferring the containers and limits any risk of containers toppling over while being transferred from an upstream platform to a downstream platform.

What is claimed is:

1. A method of transporting containers, each comprising a body having a bottom and, at its opposite end, a mouth, the method comprising the steps of:
supporting each container over a portion only of its bottom by means of a support that is movable with the container, and centering the mouth of the container on a container travel path, the centering being provided by clamping a portion of the container in the neighborhood of its mouth; and
moving the containers as supported in this way.

2. A method according to claim 1, wherein each container is supported over about half of its bottom.

3. A method according to claim 1, wherein the containers are transferred from an upstream platform towards a downstream platform, both platforms being provided with a support for each container, and wherein the containers are separated from the support of the upstream platform during the transfer.

4. A method according to claim 3, wherein separation is obtained by lowering the support of the upstream platform.

5. A method according to claim 3, wherein separation is obtained by raising the support of the downstream platform.

6. An installation for processing containers, each container comprising a body having a bottom and, at its opposite end, a mouth, the installation comprising at least one rotary platform provided with at least one support for supporting the bottoms of the containers, wherein the support is constrained to rotate with the platform and is arranged to support a portion only of the bottom of each container, and wherein the installation includes centering devices for centering the containers on a container travel path through the installation, the centering devices centering the containers by clamping onto a portion of each container in the neighborhood of its mouth.

7. An installation according to claim 6, having at least two adjacent platforms, each provided with at least one support, with the container travel path winding around at least part of each of the platforms, the supports being tangential to each other at a point where the path passes from one platform to the other.

8. An installation according to claim 7, wherein at least one of the supports is vertically movable.

9. An installation according to claim 8, wherein the vertically-movable support is situated downstream and rises to bear against the bottom of a container and separate it from the support situated upstream.

10. An installation according to claim 8, wherein the vertically-movable support is situated upstream and is lowered to place a container on the support situated downstream.

11. An installation according to claim 6, wherein the support extends at most as far as the travel path.

12. An installation according to claim 6, wherein the support comprises at least one ring sector extending around at least part of the platform to support at least one container.

13. An installation according to claim 6, having a plurality of supports each arranged to support one container.

14. An installation according to claim 13, wherein each support comprises a seat mounted to pivot about a horizontal axis between a raised position into which it is urged resiliently by a spring, and a lowered position into which it is moved by a stationary cam.

15. An installation according to claim 6, wherein the vertical position of the support is adjustable.
